(19) United States
(12) Patent Application Publication
(10) Pub. No.: US 2009/0188266 A1
(43) Pub. Date: Jul. 30, 2009

(54) HEATING, VENTILATING, AND AIR CONDITIONING SYSTEM HAVING A THERMAL ENERGY EXCHANGER

(76) Inventors: Stephen Think Hung, Grosse Pointe Park, MI (US); Lakhi Nandlal Goenka, Ann Arbor, MI (US)

Correspondence Address: FRASER CLEMENS MARTIN & MILLER LLC, 28366 KENSINGTON LANE, PERRYSBURG, OH, 43551, US

(21) Appl. No.: 12/021,557

(22) Filed: Jan. 29, 2008

(51) Int. Cl. B60H 1/32; B60H 1/34; B60H 1/00

(52) U.S. Cl. 62/239; 454/155; 237/12.3 B; 454/152

(57) ABSTRACT

A control module for a heating, ventilating, and air conditioning system for a vehicle is disclosed, the module includes a thermal energy exchanger having a phase change material disposed therein, whereby the phase change material is directly cooled and recharged by a fluid from a refrigeration system.

### FIELD OF THE INVENTION

The invention relates to a climate control system for a vehicle and more particularly to a module for a heating, ventilating, and air conditioning system for the vehicle having a thermal energy exchanger disposed therein.

### BACKGROUND OF THE INVENTION

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilating and air conditioning (HVAC) system. The HVAC system conditions air flowing therethrough and distributes the conditioned air throughout the passenger compartment.

Typically, a compressor of a refrigeration system provides a flow of a fluid having a desired temperature to an evaporator disposed in the HVAC system to condition the air. The compressor is generally driven by a fuel-powered engine of the vehicle. However in recent years, vehicles having improved fuel economy over the fuel-powered engine and other vehicles are quickly becoming more popular as a cost of traditional fuel increases. The improved fuel economy is due to known technologies such as regenerative braking, electric motor assist, and engine-off operation. Although the technologies improve fuel economy, accessories powered by the fuel-powered engine no longer operate when the fuel-powered engine is not in operation. One major accessory that does not operate is the compressor of the refrigeration system. Therefore, without the use of the compressor, the evaporator disposed in the HVAC system does not condition the air flowing therethrough and the temperature of the passenger compartment increases to a point above a desired temperature.

Accordingly, vehicle manufacturers have used a thermal energy exchanger disposed in the HVAC system to condition the air flowing therethrough when the fuel-powered engine is not in operation. One such thermal energy exchanger, also referred to as a cold accumulator, is described in U.S. Pat. No. 6,854,513 entitled VEHICLE AIR CONDITIONING SYSTEM WITH COLD ACCUMULATOR, hereby incorporated herein by reference in its entirety. The cold accumulator is disposed between a downstream side of a cooling heat exchanger and an upstream side of an air mixing door. The cold accumulator includes a phase change material, also referred to as a cold accumulating material, disposed therein. The cold accumulating material absorbs heat from the air when the fuel-powered engine is not in operation. The cold accumulating material is then recharged by the conditioned air flowing from the cooling heat exchanger when the fuel-powered engine is in operation.

In U.S. Pat. No. 6,691,527 entitled AIR-CONDITIONER FOR A MOTOR VEHICLE, hereby incorporated herein by reference in its entirety, a thermal energy exchanger is disclosed having a phase change material disposed therein. The phase change material of the thermal energy exchanger conditions a flow of air through an HVAC system when a fuel-powered engine of a vehicle is not in operation. The phase change material is recharged by a flow of a fluid from a refrigeration system therethrough. In a pull-down mode of the HVAC system, the flow of air therethrough is conditioned by an evaporator and the thermal energy exchanger. The pull-down mode of the HVAC system occurs when maximum conditioning of the air is needed to rapidly decrease a temperature of the passenger compartment of the vehicle to a desired temperature.

While the prior art HVAC systems perform adequately, it is desirable to militate against air flowing through a thermal energy exchanger disposed in the HVAC system during a pull-down mode thereof.

It is therefore considered desirable to produce a module for an HVAC system for a vehicle having a thermal energy exchanger disposed therein, wherein an effectiveness and efficiency thereof are maximized.

### SUMMARY OF THE INVENTION

In concordance and agreement with the present invention, a module for an HVAC system for a vehicle having a thermal energy exchanger disposed therein, wherein an effectiveness and efficiency thereof are maximized, has surprisingly been discovered.

In one embodiment, the control module for a heating, ventilating, and air conditioning system comprises an air flow conduit having an inlet in fluid communication with a supply of air, wherein a wall divides the air flow conduit into a first flow path and a second flow path; an evaporator disposed in the air flow conduit downstream of the inlet in fluid communication with a source of cooled fluid; a blend door disposed in the air flow conduit downstream of the evaporator, the blend door selectively positionable between a first position and a second position, wherein the blend door militates against a flow of air through the first flow path and permits the flow of air through the second flow path when positioned in the first position, and militates against the flow of air through the second flow path and permits the flow of air through the first flow path when positioned in the second position, the blend door permitting the flow of air through the first flow path and the second flow path when positioned intermediate the first position and the second position; and a thermal energy exchanger disposed in the first flow path of the air flow conduit, wherein the thermal energy exchanger is in fluid communication with at least one of the source of cooled fluid and a source of heated fluid, and wherein the thermal energy exchanger includes a phase change material disposed therein.

In another embodiment, the control module for a heating, ventilating, and air conditioning system comprises a housing forming an air flow conduit therein, the housing having an inlet providing fluid communication between a supply of air and the air flow conduit, wherein a wall divides the air flow conduit into a first flow path and a second flow path; an evaporator disposed in the housing downstream of the inlet, wherein the evaporator is in fluid communication with a source of cooled fluid, and wherein the evaporator is adapted to remove thermal energy from a flow of air therethrough when a heating, ventilating, and air conditioning system is operating in one of a pull-down mode and a thermal storage recharge mode; a blend door disposed in the air flow conduit downstream of the evaporator, the blend door selectively positionable between a first position and a second position, wherein the blend door militates against a flow of air through the first flow path and permits the flow of air through the second flow path when positioned in the first position, and militates against the flow of air through the second flow path and permits the flow of air through the first flow path when positioned in the second position, the blend door permitting the flow of air through the first flow path and the second flow path when positioned intermediate the first position and the second position; a thermal energy exchanger disposed in the first flow path of the air flow conduit, wherein the thermal energy exchanger is in fluid communication with the source of cooled fluid and includes a phase change material disposed therein, whereby a fluid from the source of cooled fluid cools and recharges the phase change material, and wherein the thermal energy exchanger is adapted to remove thermal energy from a flow of air therethrough when the heating, ventilating, and air conditioning system is operating in an engine-off mode; and a heater core disposed in the first flow path of the air flow conduit, wherein the heater core is adapted to transfer thermal energy to a flow of air therethrough when the heating, ventilating, and air conditioning system is operating in a heating mode.

In another embodiment, the heating, ventilating, and air conditioning system comprises a source of cooled fluid having a first loop and a second loop; and a control module including a housing forming an air flow conduit therein, the housing having an inlet providing fluid communication between a supply of air and the air flow conduit, wherein a wall divides the air flow conduit into a first flow path and a second flow path; an evaporator disposed in the housing downstream of the inlet, wherein the evaporator is provided in the first loop of the source of cooled fluid, and adapted to remove thermal energy from a flow of air therethrough when a heating, ventilating, and air conditioning system is operating in one of a pull-down mode and a thermal storage recharge mode; a blend door disposed in the air flow conduit downstream of the evaporator, the blend door selectively positionable between a first position and a second position, wherein the blend door militates against a flow of air through the first flow path and permits the flow of air through the second flow path when positioned in the first position, and militates against the flow of air through the second flow path and permits the flow of air through the first flow path when positioned in the second position, the blend door permitting the flow of air through the first flow path and the second flow path when positioned intermediate the first position and the second position, and wherein the blend door is in the first position when the heating, ventilating, and air conditioning system is operating in one of the pull-down mode and the thermal storage recharge mode, the second position when the heating, ventilating, and air conditioning system is operating in one of an engine-off mode and a heating mode, and intermediate the first position and the second position when the heating, ventilating, and air conditioning system is operating in one of the thermal storage recharge mode and the heating mode; a thermal energy exchanger disposed in the first flow path of the air flow conduit, wherein the thermal energy exchanger is provided in the second loop of the source of cooled fluid and includes a phase change material disposed therein, whereby a fluid from the source of cooled fluid cools and recharges the phase change material, and wherein the thermal energy exchanger is adapted to remove thermal energy from a flow of air therethrough when the heating, ventilating, and air conditioning system is operating in the engine-off mode; and a heater core disposed in the first flow path of the air flow conduit downstream of the thermal energy exchanger, wherein the heater core is adapted to transfer thermal energy to a flow of air therethrough when the heating, ventilating, and air conditioning system is operating in the heating mode.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is a schematic flow diagram of an HVAC system including a fragmentary section of a control module disposed therein according to an embodiment of the invention;

FIG. 2 is a schematic flow diagram of the HVAC system illustrated in FIG. 1, wherein a blend door is in an intermediate position; and

FIG. 3 is a schematic flow diagram of an HVAC system including a fragmentary section of a control module disposed therein according to another embodiment of the invention.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

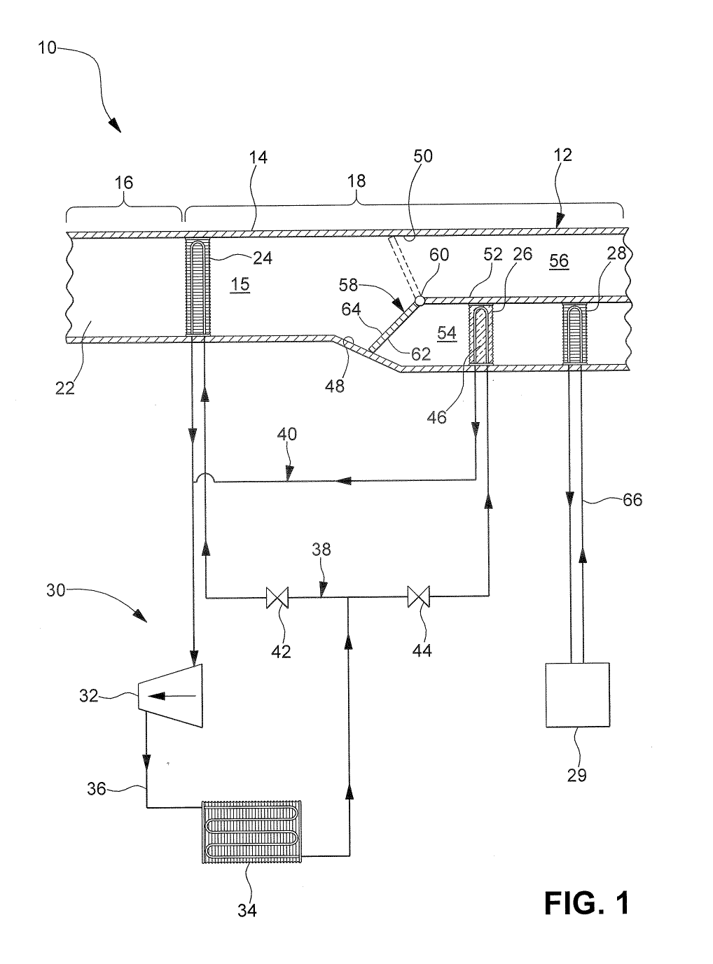

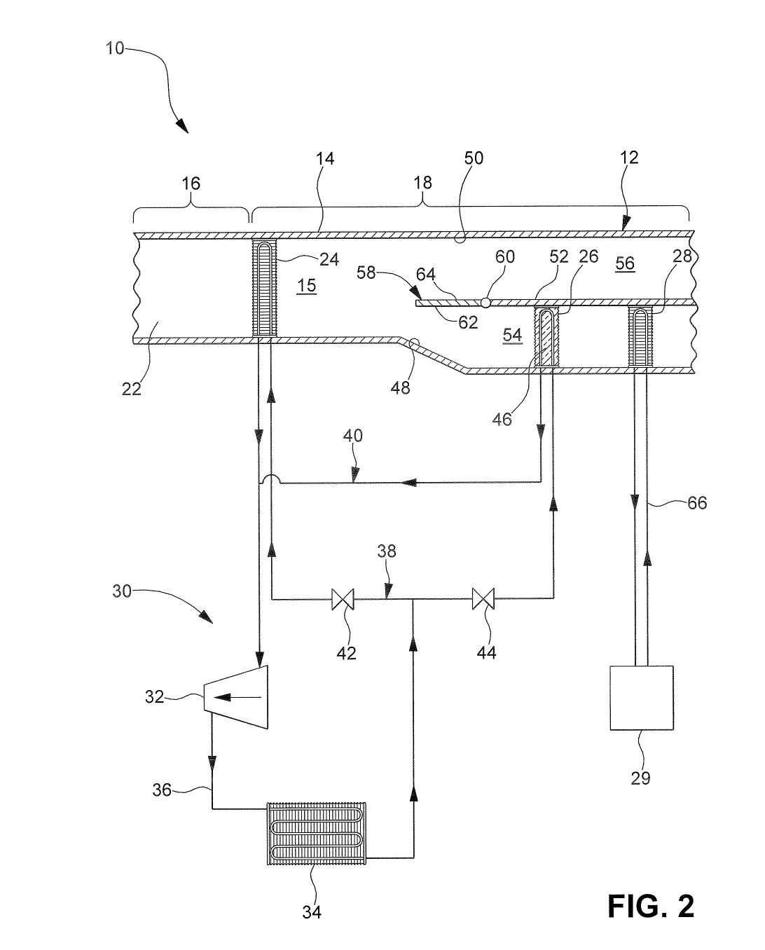

FIGS. 1 and 2 show a heating, ventilating, and air conditioning (HVAC) system 10 or climate control system according to an embodiment of the invention. As used herein the term air refers to a fluid in a gaseous state. The HVAC system 10 typically provides heating, ventilation, and air conditioning for a passenger compartment of a vehicle (not shown). The HVAC system 10 includes a control module 12 to control at least a temperature of the passenger compartment.

The module 12 illustrated includes a hollow main housing 14 with an air flow conduit 15 formed therein. The housing 14 includes an inlet section 16, a mixing and conditioning section 18, and an outlet and distribution section (not shown). In the embodiment shown, an air inlet 22 is formed in the inlet section 16. The air inlet 22 is in fluid communication with a supply of air (not shown). The supply of air can be provided from outside of the vehicle, recirculated from the passenger compartment of the vehicle, or a mixture of the two, for example. The inlet section 16 is adapted to receive a blower wheel (not shown) therein to cause air to be drawn through the air inlet 22. A filter (not shown) can be provided upstream or downstream of the inlet section 16 if desired.

The mixing and conditioning section 18 of the housing 14 is adapted to receive an evaporator core 24, a thermal energy exchanger 26, and a heater core 28 therein. In the embodiment shown, the evaporator core 24 extends over the entire width and height of the air flow conduit 15. A filter (not shown) can be provided upstream of the evaporator core 24, if desired. The heater core 28 is in fluid communication with a source of heated fluid 29. The evaporator core 24 and the thermal energy exchanger 26 are in fluid communication with a source of cooled fluid such as a refrigeration system 30, for example.

As shown, the refrigeration system 30 includes a compressor 32 and a condenser 34 fluidly connected by a conduit 36. The compressor 32 causes a fluid (not shown) to reach a super-heated state, wherein the fluid has a high pressure and a high temperature. The condenser 34, disposed downstream of the compressor 32, cools and condenses the super-heated fluid by permitting outside air to flow therethrough and transfer heat therefrom.

In the embodiment shown, the conduit 36 forms a first loop 38 and a second loop 40. The first loop 38 is provided with at least one expansion element 42 and the evaporator core 24. The at least one expansion element 42 causes the condensed fluid from the condenser 34 to decompress to a low-pressure state, wherein the fluid has a low pressure and a low temperature. The evaporator core 24 is disposed in the first loop 38 downstream of the at least one expansion element 42 to receive the decompressed fluid therethrough. The evaporator core 24 is adapted to absorb thermal energy and cool the air flowing therethrough when a fuel-powered engine of the vehicle is in operation.

The second loop 40 is provided with at least one expansion element 44 and the thermal energy exchanger 26. The at least one expansion element 44 causes the condensed fluid from the condenser 34 to decompress to a low-pressure state, wherein the fluid has a low pressure and a low temperature. The thermal energy exchanger 26 is disposed in the second loop 40 downstream of the at least one expansion element 44 to receive the decompressed fluid therein. The thermal energy exchanger 26 is adapted to absorb thermal energy and cool the air flowing therethrough when a fuel-powered engine of the vehicle is not in operation.

The thermal energy exchanger 26 includes a phase change material 46 disposed therein. It is understood that the phase change material 46 can be any conventional material such as a paraffin, an ionic liquid, water, an oil, and the like, for example. The phase change material 46 is adapted to absorb thermal energy of the air flowing through the thermal energy exchanger 26 and release thermal energy into the decompressed fluid, which flows therethrough when the fuel-powered engine of the vehicle is in operation. Each of the first loop 38 and the second loop 40 may include a shut-off valve (not shown) to selectively militate against a flow of the fluid therethrough.

As shown, the heater core 28 and the source of heated fluid 29 are fluidly connected by a conduit 66. A shut-off valve (not shown) may be disposed in the conduit 66 to selectively militate against a flow of heated fluid (not shown) therethrough. The heater core 28 is adapted to release thermal energy and heat the air flowing therethrough when a fuel-powered engine of the vehicle is in operation.

The housing 14 further includes a first housing wall 48, a second housing wall 50, and a center wall 52. The center wall 52 divides the air flow conduit 15 into a first flow path 54 and a second flow path 56. The first flow path 54 is provided with the thermal energy exchanger 26 and the heater core 28. The thermal energy exchanger 26 and the heater core 28 extend across the entire first flow path 54. In the embodiment shown, the thermal energy exchanger 26 is disposed upstream of the heater core 28. It is understood that the thermal energy exchanger 26 can be disposed downstream of the heater core 28 if desired. A blend door 58 is disposed in the air flow conduit 15 to selectively open and close the first flow path 54 and the second flow path 56. Any conventional blend door type can be used as desired. As illustrated, the blend door 58 is a flapper-type blend door including a shaft 60, on which the blend door 58 is pivotable. The shaft 60 shown is disposed in the housing 14 adjacent an upstream portion of the center wall 52, although it is understood that the shaft 60 can be disposed adjacent a downstream portion of the center wall 52 if desired. A first sealing surface 62 and a second sealing surface 64 are formed on the blend door 58.

As illustrated in FIG. 1, the blend door 58 is formed wherein at a first end stop position the HVAC system 10 can operate in a pull-down mode or a thermal storage recharge mode. It is understood that the pull down mode and the thermal storage recharge mode of the HVAC system 10 occur when the fuel-powered engine of the vehicle is in operation. It is further understood that during the pull-down mode of the HVAC system 10, the compressor 32 of the refrigeration system 30 causes the fluid therein to circulate through the first loop 38 thereof and during the thermal storage recharge mode of the HVAC system 10, the compressor 32 of the refrigeration system 30 causes the fluid therein to circulate through the first loop 38 and the second loop 40 thereof. The flow of fluid from the refrigeration system 30 through the thermal energy exchanger 26 cools and recharges the phase change material 46 disposed therein. At the first end stop position, the first sealing surface 62 is caused to abut the first housing wall 48, substantially closing the first flow path 54. Thus, at the first end stop position, the first flow path 54 is substantially closed to permit cooled air to flow from the evaporator core 24, through the second flow path 56, and into the outlet and distribution section.

The blend door 58 is further formed wherein at a second end stop position, as indicated by the dashed lines in FIG. 1, the HVAC system 10 can operate in an engine-off mode or a heating mode. It is understood that the engine-off mode of the HVAC system 10 occurs when the fuel-powered engine of the vehicle is not in operation and the heating mode of the HVAC system 10 occurs when the fuel-powered engine of the vehicle is in operation. It is further understood that during the engine-off mode, the compressor 32 of the refrigeration system 30 does not cause the fluid therein to circulate through the first loop 38 or the second loop 40 thereof, and during the heating mode of the HVAC system 10, the compressor 32 of the refrigeration system 30 does not cause the fluid therein to circulate through the second loop 40 thereof. At the second end stop position, the second sealing surface 64 is caused to abut the second housing wall 50, substantially closing the second flow path 56. Thus, at the second end stop position, the second flow path 56 is substantially closed to permit air to flow through the evaporator core 24, through the first flow path 54 to be cooled by the thermal energy exchanger 26 or heated by the heater core 28, and into the outlet and distribution section.

As illustrated in FIG. 2, the blend door 58 is further formed wherein at an intermediate position, the HVAC system 10 can operate in the thermal storage recharge mode or the heating mode. At the intermediate position of the blend door 58, the first flow path 54 and the second flow path 56 are partially open to permit cooled air to flow from the evaporator core 24 through the flow paths 54, 56, and into the outlet and distribution section. The flow of fluid from the refrigeration system 30 and cooled air from the evaporator 24 through the thermal energy exchanger 26 recharge the phase change material 46 disposed therein.

In operation, the HVAC system 10 conditions air by heating or cooling the air, and providing the conditioned air to the passenger compartment of the vehicle. Air flows through the housing 14 of the module 12. Air from the supply of air is received in the housing 14 through the air inlet 22 by the blower wheel. During rotation of the blower wheel, air is caused to flow into the air flow conduit 15 of the inlet section 16.

When the HVAC system 10 is operating in the pull-down mode, the fuel-powered engine of the vehicle is in operation. The fuel-powered engine powers the compressor 32, which causes the fluid in the refrigeration system 30 to circulate through the first loop 38 and the evaporator core 24. The air from the inlet section 16 flows into the evaporator core 24 where the air is cooled to a desired temperature and dehumidified by a transfer of thermal energy from the air to the fluid from the refrigeration system 30. The conditioned cooled air stream then exits the evaporator core 24. The blend door 58 is positioned in the first end stop position, as shown in FIG. 1, to sealingly close the first flow path 54 and militate against the flow of conditioned cooled air therethrough. Accordingly, the conditioned cooled air is permitted to bypass the thermal energy exchanger 26 and the heater core 28, and flow through the second flow path 56 into the outlet and distribution section.

When the HVAC system 10 is operating in the engine-off mode, the fuel-powered engine of the vehicle is not in operation. Therefore, the compressor 32 does not cause the fluid in the refrigeration system 30 to circulate through the first loop 38 or the second loop 40. Accordingly, the cooled fluid does not circulate through the evaporator core 24 or the thermal energy exchanger 26 and the heated fluid does not circulate through the heater core 28. The air from the inlet section 16 flows into and through the evaporator core 24 where a temperature thereof is unchanged. The blend door 58 is positioned in the second end stop position, as indicated by the dashed lines in FIG. 1, to sealingly close the second flow path 56 and militate against the flow of air therethrough. Accordingly, the air is permitted to flow through the first flow path 54 and into the thermal energy exchanger 26. In the thermal energy exchanger 26 the air is cooled to a desired temperature and dehumidified by a transfer of thermal energy from the air to the phase change material 46 disposed therein. The conditioned cooled air then exits the thermal energy exchanger 26 and flows through the heater core 28, which is not in operation, and into the outlet and distribution section.

When the HVAC system 10 is operating in the thermal storage recharge mode, the fuel-powered engine of the vehicle is in operation. The fuel-powered engine powers the compressor 32, which causes the fluid in the refrigeration system 30 to circulate through the first loop 38 and the second loop 40. Accordingly, the fluid circulates through the evaporator core 24 and the thermal energy exchanger 26. The circulation of the fluid through the thermal energy exchanger 26 causes the phase change material 46 to release thermal energy to the fluid, cooling and recharging the phase change material 46. The air from the inlet section 16 flows into the evaporator core 24 where the air is cooled to a desired temperature and dehumidified by a transfer of thermal energy from the air to the fluid from the refrigeration system 30. The conditioned cooled air stream then exits the evaporator core 24. The blend door 58 is positioned in either the first end stop position, as shown in FIG. 1, to sealingly close the first flow path 54 and militate against a flow of conditioned cooled air therethrough, or the intermediate position, as shown in FIG. 2, to partially open the first flow path 54 and the second flow path 56. Accordingly, at least a portion of the conditioned cooled air is permitted to flow through the second flow path 56 and into the outlet and distribution section. When the blend door 58 is positioned in the intermediate position, a portion of the conditioned cooled air is permitted to flow through the first flow path 54 and into the thermal energy exchanger 26. In the thermal energy exchanger 26, the conditioned cooled air further cools and recharges the phase change material 46 disposed therein. The conditioned cooled air then exits the thermal energy exchanger 26 and flows through the heater core 28, which is not in operation, into the outlet and distribution section.

When the HVAC system 10 is operating in the heating mode, the fuel-powered engine of the vehicle is in operation. The fuel-powered engine causes the fluid from the source of heated fluid 29 to circulate through the heater core 28. The air from the inlet section 16 flows into the evaporator core 24 where the air is conditioned if desired. The blend door 58 is positioned in either the second end stop position, as shown by the dashed lines in FIG. 1, or the intermediate position, as shown in FIG. 2, to permit at least a portion of the air to flow through the first flow path 54. In the first flow path 54, the air flows through the thermal energy exchanger 26, which is not in operation, and into the heater core 28. In the heater core 28, the air is heated to a desired temperature by a transfer of thermal energy from the heated fluid to the air. The heated air then exits the heater core 28 and flows into the outlet and distribution section.

A temperature of the conditioned air stream downstream of the blend door 58 can be maintained as desired between a maximum temperature equal to the temperature of the air exiting the heater core 28 with the blend door 58 in the second end stop position and a minimum temperature equal to the temperature of the air exiting the evaporator core 24 with the blend door 58 in the first end stop position. If a desired temperature between the maximum temperature and the minimum temperature is desired, the blend door 58 is positioned intermediate the first end stop position and the second end stop position until the desired temperature is reached. The intermediate position is then maintained to maintain the desired temperature. The conditioned air is then caused to exit the module 10 through the outlet and distribution section for delivery to and distribution in the passenger compartment of the vehicle.

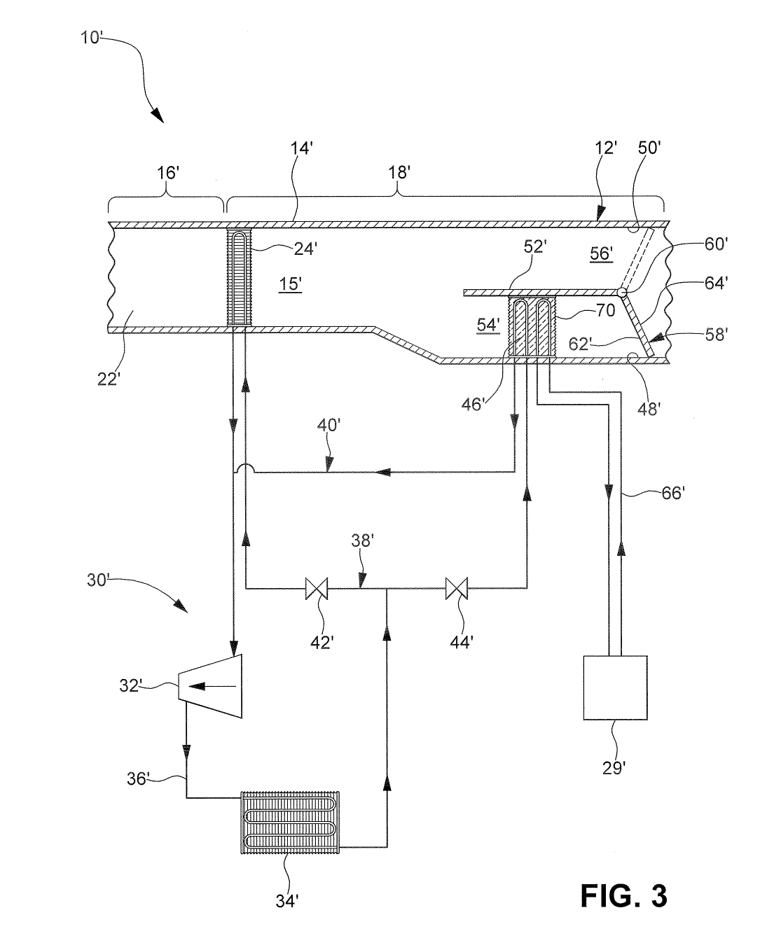

FIG. 3 shows another embodiment of the invention which includes a module similar to that shown in FIGS. 1 and 2. Reference numerals for similar structure in respect of the description of FIGS. 1 and 2 are repeated in FIG. 3 with a prime (′) symbol.

FIG. 3 shows an HVAC system 10′. The HVAC system 10′ includes a control module 12′ to control at least a temperature of the passenger compartment. The module 12′ illustrated includes a hollow main housing 14′ with an air flow conduit 15′ formed therein. The housing 14′ includes an inlet section 16′, a mixing and conditioning section 18′, and an outlet and distribution section (not shown). In the embodiment shown, an air inlet 22′ is formed in the inlet section 16′. The air inlet 22′ is in fluid communication with a supply of air (not shown). The supply of air can be provided from outside of the vehicle, recirculated from the passenger compartment of the vehicle, or a mixture of the two, for example. The inlet section 16′ is adapted to receive a blower wheel (not shown) therein to cause air to be drawn through the air inlet 22′. A filter (not shown) can be provided upstream or downstream of the inlet section 16′ if desired.

The mixing and conditioning section 18′ of the housing 14′ is adapted to receive an evaporator core 24′ and a thermal energy exchanger 70 therein. In the embodiment shown, the evaporator core 24′ extends over the entire width and height of the air flow conduit 15′. The evaporator core 24′ is in fluid communication with a source of cooled fluid such as a refrigeration system 30′, for example. A filter (not shown) can be provided upstream of the evaporator core 24′, if desired. The thermal energy exchanger 70 is in fluid communication with a source of heated fluid 29′ and the source of cooled fluid.

As shown, the refrigeration system 30′ includes a compressor 32′ and a condenser 34′ fluidly connected by a conduit 36′. The compressor 32′ causes a fluid (not shown) to reach a super-heated state, wherein the fluid has a high pressure and a high temperature. The condenser 34′, disposed downstream of the compressor 32′, cools and condenses the super-heated fluid by permitting outside air to flow therethrough and transfer heat therefrom.

In the embodiment shown, the conduit 36′ forms a first loop 38′ and a second loop 40′. The first loop 381 is provided with at least one expansion element 42′ and the evaporator core 24′. The at least one expansion element 42′ causes the condensed fluid from the condenser 34′ to decompress to a low-pressure state, wherein the fluid has a low pressure and a low temperature. The evaporator core 24′ is disposed in the first loop 38′ downstream of the at least one expansion element 42′ to receive the decompressed fluid therethrough. The evaporator core 24′ is adapted to absorb thermal energy and cool the air flowing therethrough when a fuel-powered engine of the vehicle is in operation.

The second loop 40′ is provided with at least one expansion element 44′ and the thermal energy exchanger 70. The at least one expansion element 44′ causes the condensed fluid from the condenser 34′ to decompress to a low-pressure state, wherein the fluid has a low pressure and a low temperature. The thermal energy exchanger 70 is disposed in the second loop 40′ downstream of the at least one expansion element 44′ to receive the decompressed fluid therein. The thermal energy exchanger 70 is adapted to absorb thermal energy and cool the air flowing therethrough when a fuel-powered engine of the vehicle is not in operation.

The thermal energy exchanger 70 includes a phase change material 46′ disposed therein. It is understood that the phase change material 46′ can be any conventional material such as a paraffin, an ionic liquid, water, an oil, and the like, for example. The phase change material 46′ is adapted to absorb thermal energy of the air flowing through the thermal energy exchanger 70 and release thermal energy into the decompressed fluid, which flows therethrough when the fuel-powered engine of the vehicle is in operation. Each of the first loop 38′ and the second loop 40′ may include a shut-off valve (not shown) to selectively militate against a flow of the fluid therethrough.

As shown, the thermal energy exchanger 70 and the source of heated fluid 29′ are fluidly connected by a conduit 66′ A shut-off valve (not shown) may be disposed in the conduit 66′ to selectively militate against a flow of heated fluid (not shown) therethrough. The thermal energy exchanger 70 is adapted to release thermal energy and heat the air flowing therethrough when a fuel-powered engine of the vehicle is in operation. The phase change material 46′ is adapted to release thermal energy into the air flowing through the thermal energy exchanger 70 and absorb thermal energy of the heated fluid, which flows therethrough when the fuel-powered engine of the vehicle is in operation.

The housing 14′ further includes a first housing wall 48′, a second housing wall 50′, and a center wall 52′. The center wall 52′ divides the air flow conduit 15′ into a first flow path 54′ and a second flow path 56′. The first flow path 54′ is provided with the thermal energy exchanger 70. The thermal energy exchanger 70 extends across the entire first flow path 54′. A blend door 58′ is disposed in the air flow conduit 15′ to selectively open and close the first flow path 54′ and the second flow path 56′. Any conventional blend door type can be used as desired. As illustrated, the blend door 58′ is a flapper-type blend door including a shaft 60′, on which the blend door 58′ is pivotable. The shaft 60′ as shown is disposed in the housing 14′ adjacent a downstream portion of the center wall 52′, although it is understood that the shaft 60′ can be disposed adjacent an upstream portion of the center wall 52′, as shown in FIGS. 1 and 2, if desired. A first sealing surface 62′ and a second sealing surface 64′ are formed on the blend door 58′.

As illustrated in FIG. 3, the blend door 58′ is formed wherein at a first end stop position the HVAC system 10′ can operate in a pull-down mode or a thermal storage recharge mode. It is understood that the pull down mode and the thermal storage recharge mode of the HVAC system 10′ occur when the fuel-powered engine of the vehicle is in operation. It is further understood that during the pull-down mode of the HVAC system 10′, the compressor 32′ of the refrigeration system 30′ causes the fluid therein to circulate through the first loop 38′ thereof and during the thermal storage recharge mode of the HVAC system 10′, the compressor 32′ of the refrigeration system 30′ causes the fluid therein to circulate through the first loop 38′ and the second loop 40′ thereof. The flow of fluid from the refrigeration system 30′ through the thermal energy exchanger 70 cools and recharges the phase change material 46′ disposed therein. At the first end stop position, the first sealing surface 62′ is caused to abut the first housing wall 48′, substantially closing the first flow path 54′. Thus, at the first end stop position, the first flow path 54′ is substantially closed to permit cooled air to flow from the evaporator core 241, through the second flow path 56′, and into the outlet and distribution section.

The blend door 58′ is further formed wherein at a second end stop position, as indicated by the dashed lines in FIG. 3, the HVAC system 10′ can operate in an engine-off mode or a heating mode. It is understood that the engine-off mode of the HVAC system 10′ occurs when the fuel-powered engine of the vehicle is not in operation and the heating mode of the HVAC system 10′ occurs when the fuel-powered engine of the vehicle is in operation. It is further understood that during the engine-off mode and the heating mode of the HVAC system 10′, the compressor 32′ of the refrigeration system 30′ does not cause the fluid therein to circulate through the first loop 38′ or the second loop 40′ thereof, and during the heating mode of the HVAC system 10′, the heated fluid is caused to circulated through conduit 66′. The flow of fluid from the source of heated fluid 29′ through the thermal energy exchanger 70 heats the phase change material 46′ disposed therein. At the second end stop position, the second sealing surface 64′ is caused to abut the second housing wall 50′, substantially closing the second flow path 56′. Thus, at the second end stop position, the second flow path 56′ is substantially closed to permit air to flow through the evaporator core 24′, through the first flow path 54′ to be cooled or heated by the thermal energy exchanger 70, and into the outlet and distribution section.

The blend door 58′ is further formed wherein at an intermediate position, the HVAC system 10′ can operate in the thermal storage recharge mode or the heating mode. At the intermediate position of the blend door 58′, the first flow path 54′ and the second flow path 56′ are partially open to permit cooled air to flow from the evaporator core 24′ through the flow paths 54′, 56′, and into the outlet and distribution section. The flow of fluid from the refrigeration system 30′ and cooled air from the evaporator 24′ through the thermal energy exchanger 70 recharge the phase change material 46′ disposed therein.

In operation, the HVAC system 10′ conditions air by heating or cooling the air, and providing the conditioned air to the passenger compartment of the vehicle. Air flows through the housing 14′ of the module 12′. Air from the supply of air is received in the housing 14′ through the air inlet 22′ by the blower wheel. During rotation of the blower wheel, air is caused to flow into the air flow conduit 15′ of the inlet section 16′.

When the HVAC system 10′ is operating in the pull-down mode, the fuel-powered engine of the vehicle is in operation. The fuel-powered engine powers the compressor 32′, which causes the fluid in the refrigeration system 30′ to circulate through the first loop 38′ and the evaporator core 24′. The air from the inlet section 16′ flows into the evaporator core 24′ where the air is cooled to a desired temperature and dehumidified by a transfer of thermal energy from the air to the fluid from the refrigeration system 30′. The conditioned cooled air stream then exits the evaporator core 24′. The blend door 58′ is positioned in the first end stop position, as shown in FIG. 3, to sealingly close the first flow path 54′ and militate against the flow of conditioned cooled air therethrough. Accordingly, the conditioned cooled air is permitted to bypass the thermal energy exchanger 70, and flow through the second flow path 56′ into the outlet and distribution section.

When the HVAC system 10′ is operating in the engine-off mode, the fuel-powered engine of the vehicle is not in operation. Therefore, the compressor 32′ does not cause the fluid in the refrigeration system 30′ to circulate through the first loop 38′ or the second loop 40′. Accordingly, the cooled fluid does not circulate through the evaporator core 24′ or the thermal energy exchanger 70. Further, the heated fluid does not circulate through the thermal energy exchanger 70. The air from the inlet section 16′ flows into and through the evaporator core 24′ where a temperature thereof is unchanged. The blend door 58′ is positioned in the second end stop position, as indicated by the dashed lines in FIG. 3, to sealingly close the second flow path 56′ and militate against the flow of air therethrough. Accordingly, the air is permitted to flow through the first flow path 54′ and into the thermal energy exchanger 70. In the thermal energy exchanger 70 the air is cooled to a desired temperature and dehumidified by a transfer of thermal energy from the air to the phase change material 46′ disposed therein. The conditioned cooled air then exits the thermal energy exchanger 70, and flows into the outlet and distribution section.

When the HVAC system 10′ is operating in the thermal storage recharge mode, the fuel-powered engine of the vehicle is in operation. The fuel-powered engine powers the compressor 32′, which causes the fluid in the refrigeration system 30′ to circulate through the first loop 38′ and the second loop 40′. Accordingly, the fluid circulates through the evaporator core 24′ and the thermal energy exchanger 70. The circulation of the fluid through the thermal energy exchanger 70 causes the phase change material 46′ to release thermal energy to the fluid, cooling and recharging the phase change material 46′. The air from the inlet section 16′ flows into the evaporator core 24′ where the air is cooled to a desired temperature and dehumidified by a transfer of thermal energy from the air to the fluid from the refrigeration system 30′. The conditioned cooled air stream then exits the evaporator core 24′. The blend door 58′ is positioned in either the first end stop position, as shown in FIG. 3, to sealingly close the first flow path 54′ and militate against a flow of conditioned cooled air therethrough, or the intermediate position to partially open the first flow path 54′ and the second flow path 56′. Accordingly, at least a portion of the conditioned cooled air is permitted to flow through the second flow path 56′ and into the outlet and distribution section. When the blend door 58′ is positioned in the intermediate position, a portion of the conditioned cooled air is permitted to flow through the first flow path 54′ and into the thermal energy exchanger 70. In the thermal energy exchanger 70, the conditioned cooled air further cools and recharges the phase change material 46′ disposed therein. The conditioned cooled air then exits the thermal energy exchanger 70, and flows into the outlet and distribution section.

When the HVAC system 10′ is operating in the heating mode, the fuel-powered engine of the vehicle is in operation. The fluid from the source of heated fluid 29′ is caused to circulate through the thermal heat exchanger 70. The air from the inlet section 16′ flows into the evaporator core 24′ where the air is conditioned if desired. The blend door 58′ is positioned in either the second end stop position, as shown by the dashed lines in FIG. 3, or the intermediate position to permit at least a portion of the air to flow through the first flow path 54′. In the first flow path 54′, the air flows into the thermal energy exchanger 70. In the thermal energy exchanger 70, the air is heated to a desired temperature by a transfer of thermal energy from the heated fluid to the air. The heated air then exits the thermal energy exchanger 70 and flows into the outlet and distribution section.

A temperature of the conditioned air stream downstream of the blend door 58′ can be maintained as desired between a maximum temperature equal to the temperature of the air exiting the thermal energy exchanger 70 with the blend door 58′ in the second end stop position and a minimum temperature equal to the temperature of the air exiting the evaporator core 24′ with the blend door 58′ in the first end stop position. If a desired temperature between the maximum temperature and the minimum temperature is desired, the blend door 58′ is positioned intermediate the first end stop position and the second end stop position until the desired temperature is reached. The intermediate position is then maintained to maintain the desired temperature. The conditioned air is then caused to exit the module 10′ through the outlet and distribution section for delivery to and distribution in the passenger compartment of the vehicle.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A control module for a heating, ventilating, and air conditioning system comprising:
an air flow conduit having an inlet in fluid communication with a supply of air, wherein a wall divides the air flow conduit into a first flow path and a second flow path;
an evaporator disposed in the air flow conduit downstream of the inlet in fluid communication with a source of cooled fluid;
a blend door disposed in the air flow conduit downstream of the evaporator, the blend door selectively positionable between a first position and a second position, wherein the blend door militates against a flow of air through the first flow path and permits the flow of air through the second flow path when positioned in the first position, and militates against the flow of air through the second flow path and permits the flow of air through the first flow path when positioned in the second position, the blend door permitting the flow of air through the first flow path and the second flow path when positioned intermediate the first position and the second position; and
a thermal energy exchanger disposed in the first flow path of the air flow conduit, wherein the thermal energy exchanger is in fluid communication with at least one of the source of cooled fluid and a source of heated fluid, and wherein the thermal energy exchanger includes a phase change material disposed therein.

2. The control module according to claim 1, further comprising a heater core disposed in the first flow path of the air flow conduit.

3. The control module according to claim 1, wherein the phase change material of the thermal energy exchanger is heated by a fluid from the source of heated fluid.

4. The control module according to claim 1, wherein the phase change material of the thermal energy exchanger is cooled and recharged by a fluid from the source of cooled fluid.

5. The control module according to claim 1, wherein the blend door is in the first position when a heating, ventilating, and air conditioning system is operating in one of a pull-down mode and a thermal storage recharge mode.

6. The control module according to claim 1, wherein the blend door is in the second position when a heating, ventilating, and air conditioning system is operating in one of an engine-off mode and a heating mode.

7. The control module according to claim 1, wherein the blend door is intermediate the first position and the second position when a heating, ventilating, and air conditioning system is operating in one of a thermal storage recharge mode and a heating mode.

8. The control module according to claim 1, wherein the evaporator is adapted to remove thermal energy from the air flowing therethrough when a heating, ventilating, and air conditioning system is operating in one of a pull-down mode and a thermal storage recharge mode.

9. The control module according to claim 1, wherein the thermal energy exchanger is adapted to remove thermal energy from the air flowing therethrough when a heating, ventilating, and air conditioning system is operating in an engine-off mode.

10. The control module according to claim 1, wherein the thermal energy exchanger is adapted to transfer thermal energy to the air flowing therethrough when a heating, ventilating, and air conditioning system is operating in a heating mode.

11. The control module according to claim 1, wherein the phase change material of the thermal energy exchanger is at least one of a paraffin, an ionic liquid, water, and an oil.

12. A control module for a heating, ventilating, and air conditioning system comprising:
a housing forming an air flow conduit therein, the housing having an inlet providing fluid communication between a supply of air and the air flow conduit, wherein a wall divides the air flow conduit into a first flow path and a second flow path;
an evaporator disposed in the housing downstream of the inlet, wherein the evaporator is in fluid communication with a source of cooled fluid, and wherein the evaporator is adapted to remove thermal energy from a flow of air therethrough when a heating, ventilating, and air conditioning system is operating in one of a pull-down mode and a thermal storage recharge mode;
a blend door disposed in the air flow conduit downstream of the evaporator, the blend door selectively positionable between a first position and a second position, wherein the blend door militates against a flow of air through the first flow path and permits the flow of air through the second flow path when positioned in the first position, and militates against the flow of air through the second flow path and permits the flow of air through the first flow path when positioned in the second position, the blend door permitting the flow of air through the first flow path and the second flow path when positioned intermediate the first position and the second position;
a thermal energy exchanger disposed in the first flow path of the air flow conduit, wherein the thermal energy exchanger is in fluid communication with the source of cooled fluid and includes a phase change material disposed therein, whereby a fluid from the source of cooled fluid cools and recharges the phase change material, and wherein the thermal energy exchanger is adapted to remove thermal energy from a flow of air therethrough when the heating, ventilating, and air conditioning system is operating in an engine-off mode; and
a heater core disposed in the first flow path of the air flow conduit, wherein the heater core is adapted to transfer thermal energy to a flow of air therethrough when the heating, ventilating, and air conditioning system is operating in a heating mode.

13. The control module according to claim 12, wherein the source of cooled fluid is a refrigeration system.

14. The control module according to claim 12, wherein the blend door is in the first position when the heating, ventilating, and air conditioning system is operating in one of the pull-down mode and the thermal storage recharge mode.

15. The control module according to claim 12, wherein the blend door is in the second position when the heating, ventilating, and air conditioning system is operating in one of the engine-off mode and the heating mode.

16. The control module according to claim 12, wherein the blend door is intermediate the first position and the second position when the heating, ventilating, and air conditioning system is operating in one of the thermal storage recharge mode and the heating mode.

17. The control module according to claim 12, wherein the phase change material of the thermal energy exchanger is at least one of a paraffin, an ionic liquid, water, and an oil.

18. A heating, ventilating, and air conditioning system comprising:
a source of cooled fluid having a first loop and a second loop; and
a control module including a housing forming an air flow conduit therein, the housing having an inlet providing fluid communication between a supply of air and the air flow conduit, wherein a wall divides the air flow conduit into a first flow path and a second flow path; an evaporator disposed in the housing downstream of the inlet, wherein the evaporator is provided in the first loop of the source of cooled fluid, and adapted to remove thermal energy from a flow of air therethrough when a heating, ventilating, and air conditioning system is operating in one of a pull-down mode and a thermal storage recharge mode; a blend door disposed in the air flow conduit downstream of the evaporator, the blend door selectively positionable between a first position and a second position, wherein the blend door militates against a flow of air through the first flow path and permits the flow of air through the second flow path when positioned in the first position, and militates against the flow of air through the second flow path and permits the flow of air through the first flow path when positioned in the second position, the blend door permitting the flow of air through the first flow path and the second flow path when positioned intermediate the first position and the second position, and wherein the blend door is in the first position when the heating, ventilating, and air conditioning system is operating in one of the pull-down mode and the thermal storage recharge mode, the second position when the heating, ventilating, and air conditioning system is operating in one of an engine-off mode and a heating mode, and intermediate the first position and the second position when the heating, ventilating, and air conditioning system is operating in one of the thermal storage recharge mode and the heating mode; a thermal energy exchanger disposed in the first flow path of the air flow conduit, wherein the thermal energy exchanger is provided in the second loop of the source of cooled fluid and includes a phase change material disposed therein, whereby a fluid from the source of cooled fluid cools and recharges the phase change material, and wherein the thermal energy exchanger is adapted to remove thermal energy from a flow of air therethrough when the heating, ventilating, and air conditioning system is operating in the engine-off mode; and a heater core disposed in the first flow path of the air flow conduit downstream of the thermal energy exchanger, wherein the heater core is adapted to transfer thermal energy to a flow of air therethrough when the heating, ventilating, and air conditioning system is operating in the heating mode.

19. The heating, ventilating, and air conditioning system according to claim 18, wherein the source of cooled fluid is a refrigeration system.

20. The heating, ventilating, and air conditioning system according to claim 18, wherein the phase change material of the thermal energy exchanger is at least one of a paraffin, an ionic liquid, water, and an oil.
